(19) United States
(12) Patent Application Publication
(10) Pub. No.: US 2025/0289102 A1
(43) Pub. Date: Sep. 18, 2025

(54) DISCONNECT COUPLING

(71) Applicant: C. & E. Fein GmbH, Schwaebisch Gmuend/ Bargau (DE)

(72) Inventors: Vishnuvardhan YOGESHWARAN, Boebingen an der Rems (DE); Frank SCHIMKO, Besigheim (DE)

(73) Assignee: C. & E. Fein GmbH, Schwaebisch Gmuend/ Bargau (DE)

(21) Appl. No.: 19/077,935

(22) Filed: Mar. 12, 2025

(30) Foreign Application Priority Data
Mar. 12, 2024 (EP) 24163036

(51) Int. Cl. B25B 23/14

(52) U.S. Cl. CPC B25B 23/141

(57) ABSTRACT

A torque-dependent releasable disconnect coupling for an electric hand-held power tool, in particular a screwdriver, for selectively transmitting a torque from a drive shaft to an output shaft that is coaxial with respect to the drive shaft. An axially nondisplaceable guide ring guides a switching element, in particular a ball, and a second guide ring. A cam ring and the second guide ring are axially pretensioned against one another and accommodate the switching element axially between them. The disconnect coupling may be brought from a first, non-torque-transmitting switching position into a second, torque-transmitting switching position. The switching element is deflected in the axial direction relative to the cam ring, against the action of the pretensioning, when a first release torque in the first switching position is exceeded, thus bringing he disconnect coupling into the second switching position.

This nonprovisional application claims priority under 35 U.S.C. § 119(a) to European Patent Application No. 24163036.7, which was filed on Mar. 12, 2024, and which is herein incorporated by reference.

### BACKGROUND OF THE INVENTION

### Field of the Invention

The invention relates to a torque-dependent releasable disconnect coupling for an electric hand-held power tool, in particular a screwdriver, for selectively transmitting a torque from a drive shaft to an output shaft that is coaxial with respect to the drive shaft, and to a method for operating an electric hand-held power tool having such a disconnect coupling.

### Description of the Background Art

The invention is described below using the example of a screwdriver. In particular, the invention is provided for use in an industrial screwdriver. However, this is not to be construed as limiting. The invention may also be used with other electric hand-held power tools such as drills or grinders.

The screwdrivers under consideration here, or also cordless screwdrivers, are used in particular for screw connection applications for mass production, for example in the manufacture of automobiles.

For screw connections, in particular those in the industrial sector, a nominal tightening torque at which the screw connection is to be tightened is often specified. The tightening torque increases as the screw connection is being established. Therefore, for the screwdriver there is a requirement that when the nominal tightening torque is reached, the torque transmission is to be interrupted and in particular the motor of the screwdriver is to be switched off.

For this purpose, these types of screwdrivers have a disconnect coupling in their powertrain which opens upon reaching a settable torque.

Such a disconnect coupling is known, for example, from EP 3 361 114 B1, which is incorporated herein by reference. The disconnect coupling has a first coupling element and a second coupling element which cooperate to transmit a torque, at least one of the two coupling elements being movable relative to the other coupling element and being pretensioned by a spring element. The two coupling elements are coupled in a form-fit manner via at least one ball, so that a torque can be transmitted between the two coupling elements. At least one coupling element also has one cam element for each ball as a form-fit element. When the torque reaches a certain value, the ball, due to the circumferential force acting on it, begins to run up on the cam element with a slope that is less than 90 degrees (relative to the direction of the circumferential force). In this way, the coupling releases or “opens” when this torque is exceeded.

A further disconnect coupling is known from DE 10 2020 130 665 A1, which is incorporated herein by reference. The two coupling elements are a cam ring and a switching ring, which likewise are axially pretensioned against one another and coupled in a form-fit manner by balls. The cam ring has a cam track that is closed in the circumferential direction, with at least one switching cam against which the ball rests when the disconnect coupling is closed. When a release torque is exceeded, the ball is introduced into a freewheeling track that is formed in the cam ring, so that torque is no longer transmittable between the two coupling elements.

### SUMMARY OF THE INVENTION

It is therefore an object of the present invention to further improve a disconnect coupling for an electric hand-held power tool, and to provide a method for operating an electric hand-held power tool having such a disconnect coupling.

A torque-dependent releasable disconnect coupling according to the invention for an electric hand-held power tool, in particular a screwdriver, for selectively transmitting a torque from a drive shaft to an output shaft that is coaxial with respect to the drive shaft comprises: a cam ring that is rotatably fixedly connectable to the drive shaft or to the output shaft, and an axially nondisplaceable first guide ring that is rotatably fixedly connectable to the other of the drive shaft and the output shaft.

The disconnect coupling may be brought from a first switching position, in which the cam ring is connected in a torque-transmitting manner to the first guide ring in a first rotational direction, in particular clockwise in the axial direction viewed from the drive shaft toward the output shaft, into a second switching position in which the cam ring is freely rotatable with respect to the first guide ring.

Furthermore, the disconnect coupling according to the invention comprises: at least one switching element, in particular a ball, that is guided from the first guide ring in the circumferential direction and/or in the radial direction, and a second guide ring, wherein the cam ring and the second guide ring are axially pretensioned against one another and accommodate the at least one switching element axially between them.

The cam ring is designed in such a way that when the disconnect coupling is in the first switching position, the at least one switching element is deflected in the axial direction relative to the cam ring, against the action of the pretensioning, when a first release torque that acts in the first rotational direction is exceeded, as a result of which the disconnect coupling is brought into the second switching position.

A disconnect coupling that reliably opens when the first release torque is exceeded, is robust, and has a simple design is thus provided, thereby achieving the object of improving the disconnect coupling.

The accommodation of the at least one switching element between the cam ring and the second guide ring, which are axially pretensioned against one another, together with the guiding of the at least one switching element in the circumferential direction and/or in the radial direction by the first guide ring, results in the movement of the at least one switching element always being controlled in all directions, and the disconnect coupling thus being unable to assume undefined states.

Since the axial pretensioning acting on the at least one switching element takes place only between the cam ring and the second guide ring, and the first guide ring is not involved, it is possible according to the invention for the first guide ring to be arranged so that it is axially nondisplaceable. The rotatably fixed connection between the first guide ring and the drive shaft or output shaft may thus be implemented more easily, in particular by a rigid or even one-piece connection, than if the first guide ring had to be axially displaceable.

Accordingly, it is preferred that the cam ring is also axially nondisplaceable, since the rotatably fixed connection between the cam ring and the drive shaft or output shaft is then also easier to implement than if the cam ring had to be axially displaceable. It is thus preferred that instead, the second guide ring is axially displaceable in order to achieve the axial pretensioning between the cam ring and the second guide ring as well as the deflectability of the at least one switching element against this pretensioning. In contrast, the second guide ring is not involved in the torque transmission from the drive shaft to the output shaft, and therefore also requires no rotatably fixed connection to one of these shafts.

In particular, the following first application is assisted by use of the disconnect coupling according to the invention: When a screw connection is established, in particular made up of a screw having an external thread, and a mating piece, preferably a fastening section, in particular an opening, having an internal thread, the disconnect coupling is to open in the clockwise operational direction of the hand-held power tool as soon as the nominal tightening torque of the screw connection is reached. In this case, the first release torque is thus to correspond to this nominal tightening torque. Therefore, the task of the first application is to protect the screw connection from overtightening and thus, possible damage to the screw or the mating piece.

In an example of the invention the cam ring comprises: at least one depression, in particular a ball pocket, in which the at least one switching element is accommodated in the first switching position, wherein the at least one depression forms a first switching cam against which the at least one switching element rests in the first switching position; a freewheeling track, closed in the circumferential direction, on which the at least one switching element can circulate in the second switching position; and at least one discharge track that connects the at least one depression and the freewheeling track, and on which the at least one switching element can move from the at least one depression to the freewheeling track and vice versa.

The freewheeling track and the at least one discharge track can be formed by respective elongated recesses in a surface of the cam ring that preferably extends in a plane perpendicular to the axial direction. The freewheeling track and the at least one discharge track thus preferably form grooves in the surface of the cam ring, which more preferably have a circular segment-shaped cross section.

When the first release torque is exceeded, the at least one switching element is deflectable in the axial direction, and the disconnect coupling may be brought into the second switching position by moving the at least one switching element from the at least one depression, via the at least one discharge track, into the freewheeling track.

In this way, the first and second switching positions of the disconnect coupling may be easily and reliably defined by the position of the at least one switching element in the at least one depression or in the freewheeling track. Due to the freewheeling track which is closed in the circumferential direction, the at least one switching element may also circulate there for as long as desired, so that the disconnect coupling may remain for any desired length of time in the second switching position, and thus in the open state.

The axial level of the at least one discharge track can rise from the depression in the direction of the freewheeling track, and is always lower than or at the same height as the axial level of the freewheeling track.

An axial level is defined as a depth in the surface of the cam ring; i.e., a lower axial level may mean a deeper recess in the surface of the cam ring.

To allow the transition of a switching element from the freewheeling track into the discharge track to reliably take place, the freewheeling track and the at least one discharge track preferably have different levels in the axial direction. While the freewheeling track preferably has a constant level, the at least one discharge track preferably continuously rises, starting from the first switching cam at the at least one depression in the cam ring, until it reaches the level of the freewheeling track at the branch or opening of both tracks. At this location the freewheeling track and the at least one discharge track preferably have the same radii or shapes, and merge into one another with a “smooth” transition.

Due to the various axial levels of the freewheeling track and of the at least one discharge track and their arrangement, a step-like transition is preferably formed between these two tracks which is transverse to the running direction of the tracks. This step-like transition preferably forms a guide. This ensures that a switch of a switching element from the at least one discharge track into the freewheeling track and vice versa can occur only at the opening between the freewheeling track and the at least one discharge track.

The stated guide at the transition between the at least one discharge track and the freewheeling track may be advantageous in particular when the disconnect coupling has more than one switching element, and has a discharge track for each switching element. As a result of the guide, it may be ensured that all used switching elements switch at the same time at the respective opening between the freewheeling track and each of the discharge tracks between same. The situation may thus be prevented that during a change in rotational direction, a first switching element switches into one of the discharge tracks while a second switching element is still present in the freewheeling track.

An axial displacement of the cam ring and/or of the second guide ring may be brought about by the axial deflection of the at least one switching element as a result of the first release torque, and the disconnect coupling additionally has a sensor that is configured to detect this displacement.

The detection of the axial displacement of the cam ring and/or of the second guide ring may advantageously be utilized to recognize the second switching position, and thus the open state of the disconnect coupling. During operation of a hand-held power tool having a disconnect coupling according to the invention, the motor controller for the drive motor of the hand-held power tool can trigger a change in the rotational direction of the motor, as a result of which the at least one switching element returns from the freewheeling track, via the at least one discharge track, back into the at least one depression, so that the disconnect coupling returns into the first switching position and once again closes.

The first guide ring can be designed as a cage ring having at least one through opening, and the at least one switching element is accommodated in the at least one through opening.

Due to the design of the first guide ring as a cage ring, the receiving space for the at least one switching element is closed with respect to the surroundings, in particular in the radial direction, so that the at least one switching element, even under the effect of the centrifugal force during the rotation of the disconnect coupling, cannot leave the first guide ring, as the result of which it could possibly “get lost” inside the housing of the hand-held power tool.

The at least one through opening can have an elongated shape, in particular an elongated straight shape, whose direction of extension is inclined with respect to a radial direction. Alternatively, the through opening may have a shape that differs from a straight shape, for example a slightly curved shape.

An inclination of the direction of extension of the at least one through opening in the first guide ring with respect to a radial direction is advantageous for the radial movement of the at least one switching element during the transition of the disconnect coupling from the first into the second switching position, in which the at least one switching element moves radially inwardly. Due to the direction of extension of the at least one through opening being inclined with respect to a radial direction, during this movement the at least one switching element can “slide down” on the inner wall of the at least one through opening, similarly to a sloping wall, which reduces friction and prevents self-locking between the at least one switching element and the first guide ring.

The first guide ring can be situated axially between the cam ring and the second guide ring, and the at least one switching element on both sides protrudes axially beyond the edge of the at least one through opening.

Due to the axial arrangement of the first guide ring between the cam ring and the second guide ring, forced guidance of the at least one switching element in all directions is achieved, namely, axially between the cam ring and the second guide ring, and radially and/or in the circumferential direction via the first guide ring.

Due to the axial protrusion of the at least one switching element beyond the side faces of the first guide ring or beyond the edge of the at least one through opening in the first guide ring, it is further ensured that the second guide ring can always be in axial contact with the at least one switching element without colliding with the edge of the at least one through opening. The edge of the at least one through opening preferably lies in a plane with a side face of the first guide ring. It is likewise ensured that the cam ring can always be in axial contact with the at least one switching element without colliding with the edge of the at least one through opening in the first guide ring. The axial protrusion of the at least one switching element on both sides of the first guide ring is preferably dimensioned in such a way that the above statement applies for any axial position of the at least one switching element in the recesses in the cam ring or in the at least one through opening in the first guide ring.

In an example of the invention having at least one depression in the cam ring, the at least one depression is situated inside the cam ring. This means that the depression, preferably in the form of a recess or a ball pocket, is spaced apart from the outer circumference of the cam ring. The outer circumference of the cam ring in the area of the depression is preferably greater than the depression, so that the depression is radially closed toward the outside.

This may have the advantage, similarly as for the design of the first guide ring as a cage ring, that the at least one switching element, even under the effect of the centrifugal force during the rotation of the disconnect coupling, does not leave the cam ring, as the result of which it could possibly “get lost” inside the housing of the hand-held power tool.

The at least one depression can have an elongated shape, at a first end merges into the at least one discharge track, and can have a lower axial level than the at least one discharge track. The transition of the depression into the discharge track forms the first switching cam.

This example of the at least one depression represents a simple option for forming the first switching cam in the recesses in the cam ring, and thus allowing the at least one switching element, after overcoming the first switching cam, to make a direct transition into the at least one discharge track. Due to the lower axial level of the at least one depression compared to the axial level of the at least one discharge track, at the same time this brings about the desired axial deflection of the at least one switching element upon overcoming the first switching cam.

The transition at the first end of the at least one depression, from the at least one depression into the at least one discharge track, viewed in the direction of extension of the at least one depression and the at least one discharge track, may be essentially smooth.

This may result in a uniform and—aside from the jolt caused by overcoming the first switching cam—jerk-free movement of the at least one switching element on its path from the at least one depression into the at least one discharge track.

In an example of the invention having at least one depression, a freewheeling track, and at least one discharge track in the cam ring, the freewheeling track has a constant axial level.

This may result in a particularly uniform movement of the at least one switching element in the second switching state. This results in a low-wear, low-vibration, and/or low-noise switching operation. In addition, due to the constant axial level of the freewheeling track, any further axial deflection of the at least one switching element and an associated axial displacement of the cam ring and/or of the second guide ring are avoided, so that the transition from the first to the second switching position may be reliably detected, which likewise achieves the object of improving the disconnect coupling.

In an example of the invention having at least one depression, a freewheeling track, and at least one discharge track in the cam ring, the at least one discharge track can have, at least in part, the shape of a logarithmic spiral.

This may likewise result in a uniform and jerk-free radially inward movement of the at least one switching element on the at least one discharge track.

The disconnect coupling may be brought from a third switching position, in which the cam ring is connected in a torque-transmitting manner to the first guide ring in a second rotational direction opposite to the first rotational direction, in particular counterclockwise in the axial direction viewed from the drive shaft toward the output shaft, into a fourth switching position in which the cam ring is freely rotatable with respect to the first guide ring.

The cam ring can be designed in such a way that when the disconnect coupling is in the third switching position, the at least one switching element is deflected in the axial direction relative to the cam ring, against the effect of the pretensioning, when a second release torque that acts in the second rotational direction is exceeded, as a result of which the disconnect coupling is brought into the fourth switching position.

A disconnect coupling can be thus provided which reliably opens when the second release torque is exceeded, is robust, and has a simple design.

As a result of this example of the disconnect coupling according to the invention, in particular the following, second application is assisted: When a screw connection is loosened in the counterclockwise operational direction of the hand-held power tool, with a seized screw connection it may be necessary for the torque required for loosening to be greater than the motor torque. Operation of the hand-held power tool with such high torque could result in damage to the motor. Therefore, the disconnect coupling is to open even before the maximum motor torque is reached. In this case, the second release torque should therefore be somewhat less than the maximum motor torque. Thus, the second application is intended to protect the motor of the hand-held power tool from overload and damage.

In an example of the invention, in which at least one depression is also provided in the cam ring, the at least one switching element in the third switching position is accommodated in the at least one depression, wherein the at least one depression forms a second switching cam against which the at least one switching element rests in the third switching position.

The cam ring also has a cam track that is largely closed in the circumferential direction and interrupted only by the at least one depression, and on which the at least one switching element in the fourth switching position can circulate, at least in parts.

Furthermore, the at least one switching element is deflectable in the axial direction when the second release torque is exceeded, and the disconnect coupling may be brought into the fourth switching position by moving the at least one switching element from the at least one depression into the cam track.

With this example of the cam ring, it is possible to achieve essentially the same advantages as described above for the first and second switching positions, namely, that the third and fourth switching positions of the disconnect coupling may thus be easily and reliably defined by the position of the at least one switching element in the at least one depression or in the cam track. In contrast to the second switching position, however, the fourth switching position is maintained only until the at least one switching element falls out of the cam track and into the next depression. However, the duration of this movement may be sufficient to detect the fourth switching position and respond thereto.

The at least one depression can have an elongated shape, at a second end merges into the cam track, and can have a lower axial level than the cam track, the second switching cam being formed by this transition.

This may result in the corresponding advantages as in the variant described above, in which at a first end the at least one depression merges into the at least one discharge track and has a lower axial level than the at least one discharge track, a first switching cam being formed by this transition.

The second end of the at least one depression, with regard to its elongated shape, can be situated opposite from such a first end.

An axial displacement of the cam ring and/or of the second guide ring may be brought about by the axial deflection of the at least one switching element due to the second release torque, and the disconnect coupling also has a sensor that is configured to detect this displacement.

This may be utilized, similarly as above for the second switching position, to detect the fourth switching position and thus the open state of the disconnect coupling. However, after this detection it is not necessary to reverse the rotational direction of the motor, since in this case the at least one switching element can remain in the cam track, and also during further operation of the motor in the same rotational direction, can return into a depression, wherein this depression is then the depression that follows in the circumferential direction, and as a result the disconnect coupling can also return into the third switching position.

Of course, the sensor for detecting the fourth switching position may be identical to the sensor for detecting the second switching position, since in both cases an axial displacement of the cam ring and/or of the second guide ring is detected.

In an example of the invention in which the first and second switching cams are formed by a transition at a first end and second end, respectively, of the at least one depression, the inner wall of the at least one depression at its second end is steeper than the inner wall of the at least one depression at its first end, so that the second release torque is greater than the first release torque.

The described relationship, that the release torque is greater the steeper the transition at the respective end of the at least one depression, results directly from the above-described cooperation of the at least one switching element with the respective inner wall of the at least one depression (the “ramp”) within the meaning of a wedge gear. The second release torque being greater than the first release torque may be advantageous, since the maximum motor torque, according to which the second release torque is to be dimensioned, is generally greater than the nominal tightening torque of a screw connection, according to which the first release torque is to be dimensioned.

The cam track can have a constant axial level except in the area of the at least one depression.

This may result in the same advantages as in the corresponding example with a constant axial level of the freewheeling track, namely, that in this case the transition from the third to the fourth switching position may be reliably detected.

The disconnect coupling can have a freewheel that can be opened and closed, and which is configured to be supported on a housing of the electric hand-held power tool, and which in the closed (activated) state allows rotation of the output shaft in the first rotational direction and blocks rotation of the output shaft in the second rotational direction, and in the open (deactivated) state does not affect the rotatability of the output shaft.

A freewheel having these functions is advantageous when, in the second switching position, the rotational direction of the motor is reversed from the first into the second rotational direction in order to lead the at least one switching element from the freewheeling track, via the at least one discharge track, back into the at least one depression. In this case, the output shaft must be prevented from co-rotating, since otherwise the necessary relative rotation between the drive shaft and the output shaft does not occur. In this case, the freewheel may thus be closed so that it blocks the rotation of the output shaft in the second rotational direction, thus preventing co-rotation of the output shaft in the second rotational direction.

The freewheel can be a ratchet-type freewheel in which at least one freewheel ratchet engages with at least one freewheel tooth. The at least one freewheel ratchet is situated on an axially displaceable, nonrotatable freewheel ratchet ring that is axially pretensioned against the at least one freewheel tooth, and the at least one freewheel tooth is situated at an end-face side of the first guide ring.

The example as a ratchet-type freewheel represents a common structural design of a freewheel and is therefore easy to implement. In particular, using the first guide ring for attaching the at least one freewheel tooth may be advantageous, since this requires no additional component for mounting the freewheel tooth.

The freewheel may be closed and opened by an axial displacement of the freewheel ratchet ring, which may be achieved by axially displacing the second guide ring.

When the transition from the first to the second switching position and/or the transition from the third to the fourth switching position can bring about an axial displacement of the second guide ring, it is also advantageous for this displacement to bring about the closing and opening of the freewheel. Since the freewheel ratchet ring is axially displaceable, it is also advantageous to bring about the closing and opening of the freewheel also by means of such an axial displacement of the freewheel ratchet ring. In this way, use is made of the movement options of the involved components, which are present anyway, for closing and opening the freewheel.

Bringing about the axial displacement of the freewheel ratchet ring via the axial displacement of the second guide ring may be direct or indirect. In a direct action, the freewheel ratchet ring may be directly supported on the second guide ring in the axial direction. In an indirect action, at least one further force-transmitting component, in particular a component that is connected to the second guide ring and that is axially displaceable therewith, but itself is nonrotatable, may be situated between the second guide ring and the freewheel ratchet ring.

The cam ring and the first guide ring can be situated axially between the freewheel ratchet ring and the second guide ring, and the second guide ring or a component that is connected to the second guide ring and axially nondisplaceable with respect to same axially overlaps the cam ring and the first guide ring.

When closing and opening of the freewheel via an axial displacement of the second guide ring, and an axial displacement of the freewheel ratchet ring brought about by same, are to take place, the second guide ring must be able to act axially on the freewheel ratchet ring. When the cam ring and the first guide ring are still situated axially therebetween, this may be easily achieved by the second guide ring, or a component that is connected to the second guide ring and axially nondisplaceable with respect to same, axially overlapping the two latter components. This also includes the case that the axial displacement of the freewheel ratchet ring is indirectly brought about by the axial displacement of the second guide ring, and a further force-transmitting component that is connected to the second guide ring but axially nondisplaceable with respect to same axially overlaps the cam ring and the first guide ring.

The freewheel can be open in the first switching position and closed in the second switching position.

This meets the requirement that the freewheel is to be closed when, after the transition from the first into the second switching position, the rotational direction of the motor is reversed from the first into the second rotational direction to prevent co-rotation of the output shaft in the second rotational direction.

Since in contrast, after the transition from the third into the fourth switching position, as described above, it is not necessary to reverse the motor rotational direction, in this case it is not relevant whether the freewheel is closed or open.

The invention further relates to an electric hand-held power tool, in particular a screwdriver, having a disconnect coupling according to the invention. The two applications described above for the clockwise and counterclockwise operation of the motor of the hand-held power tool may thus be easily and reliably implemented.

The invention further relates to a method for operating an electric hand-held power tool, in particular a screwdriver, having a disconnect coupling according to the invention, comprising the steps: driving the drive shaft in the first rotational direction while the disconnect coupling is in the first switching position; stopping the rotation of the drive shaft when a torque that exceeds the first release torque acts in the first rotational direction, the disconnect coupling being brought into the second switching position by the exceedance of the first release torque; and driving the drive shaft in the second rotational direction, thus bringing the disconnect coupling back into the first switching position.

This corresponds to the first application, described in detail above, in which the disconnect coupling is to open as soon as the nominal tightening torque of the screw connection to be established is reached, and afterwards is to close again.

The invention further relates to a method for operating an electric hand-held power tool, in particular a screwdriver, having a disconnect coupling, which may also be brought into the third and fourth switching positions, comprising the steps: driving the drive shaft in the second rotational direction while the disconnect coupling is in the third switching position; continuing to drive the drive shaft in the second rotational direction when a torque that exceeds the second release torque acts in the second rotational direction, the disconnect coupling being brought into the fourth switching position by the exceedance of the second release torque; and continuing to drive the drive shaft in the second rotational direction, thus bringing the disconnect coupling back into the third switching position.

This corresponds to the second application, likewise described in detail above, in which the disconnect coupling is to open before the maximum motor torque is reached in order to protect the motor from overload, and afterwards is to close again.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a disconnect coupling according to the invention;

FIG. 2 shows a cross section of the disconnect coupling according to FIG. 1;

FIG. 3 shows an exploded illustration of the disconnect coupling according to FIG. 1;

FIG. 4 shows the components of the disconnect coupling according to FIG. 1;

FIG. 5 shows the end-face side of the cam ring of the disconnect coupling according to FIG. 1; and

FIG. 6 shows the components of the disconnect coupling according to FIG. 1, which form the reset mechanism.

### DETAILED DESCRIPTION

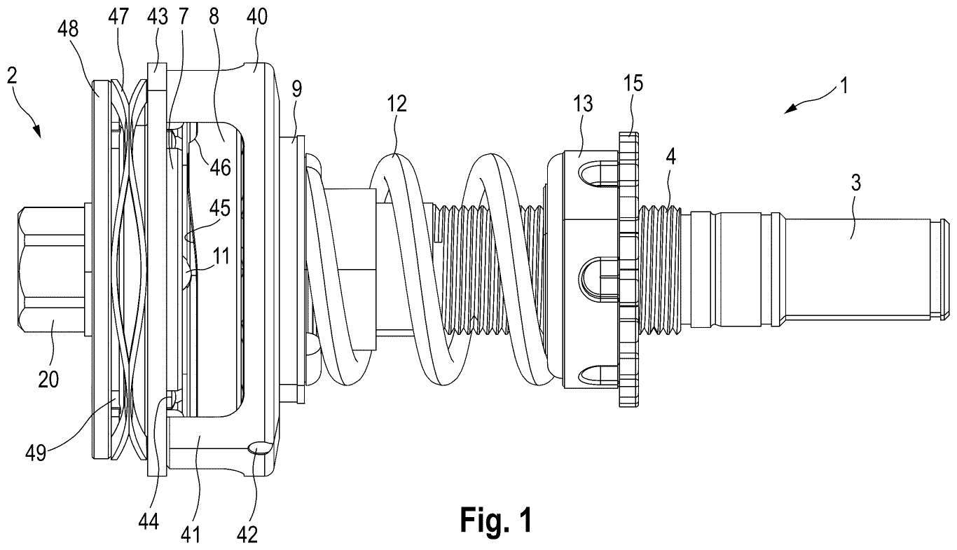

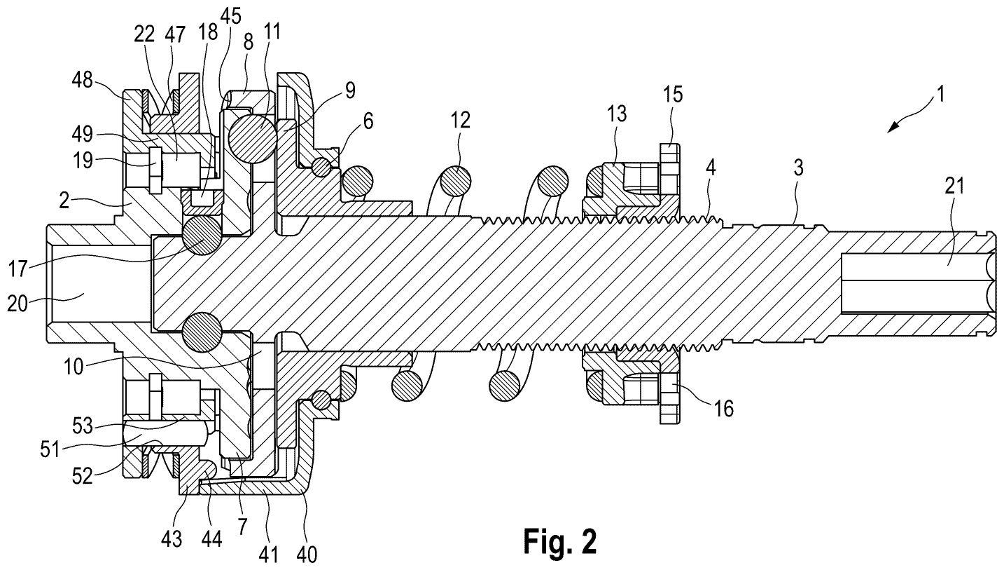

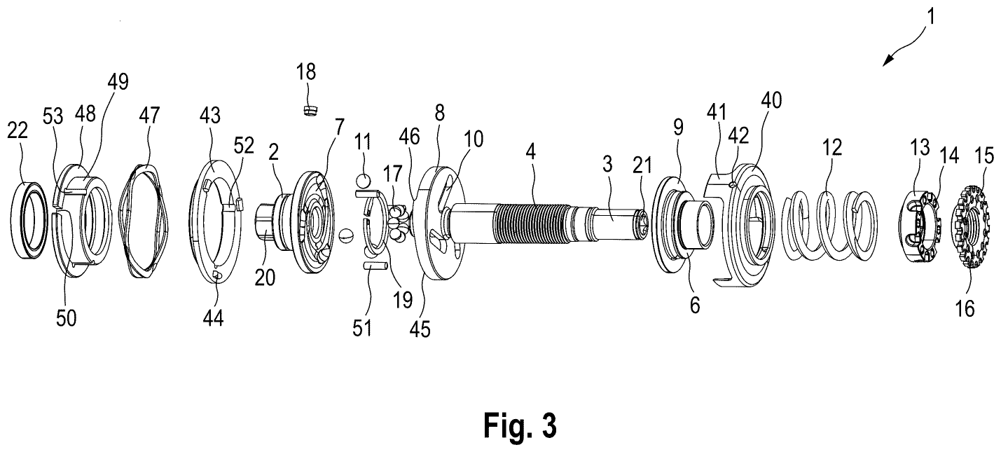

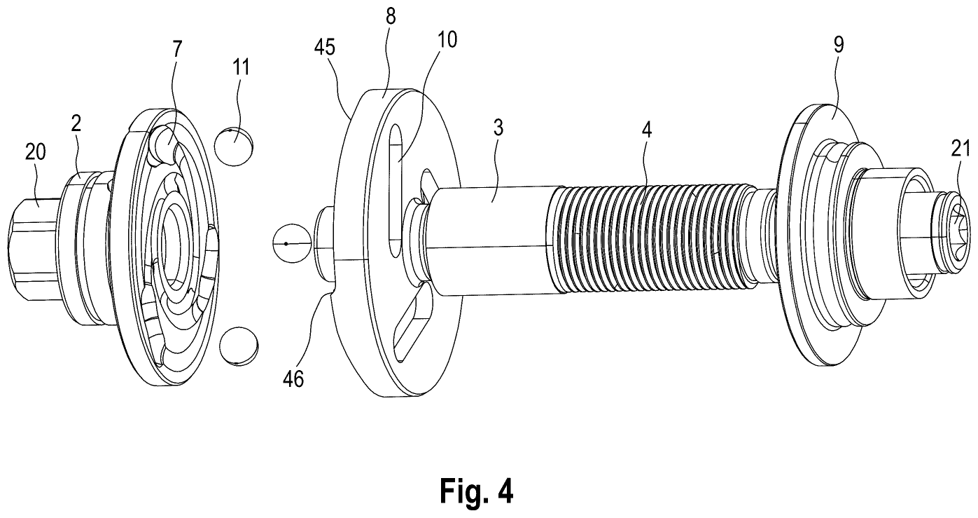

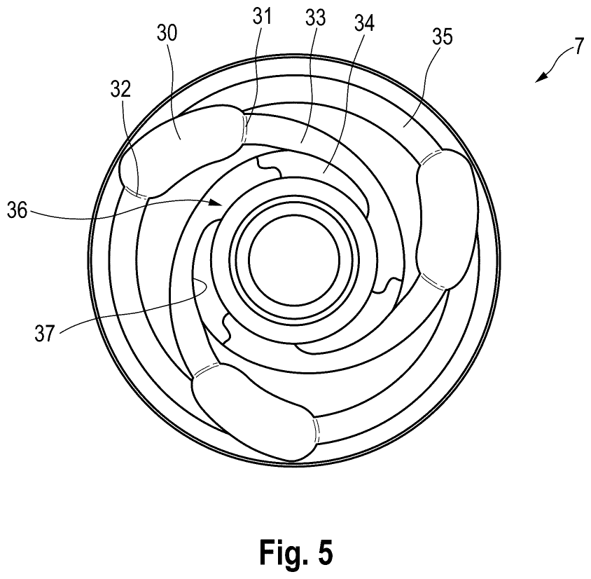

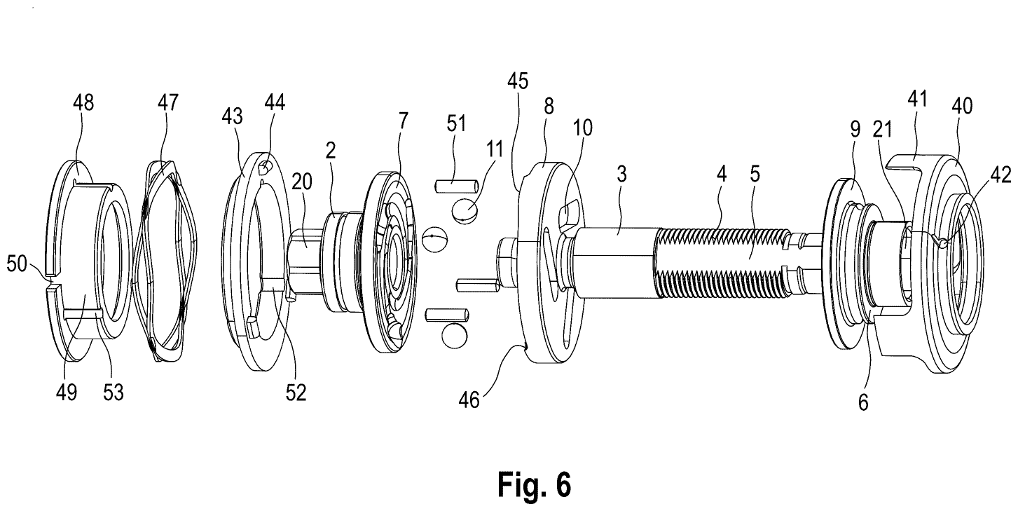

The invention is described in detail below with reference to an example of a disconnect coupling 1 according to the invention. FIGS. 1, 2, and 3 show the entire disconnect coupling 1 in various views, namely, as a side view (FIG. 1), a cross section (FIG. 2), and an exploded illustration (FIG. 3). FIGS. 4, 5, and 6 show individual components or subassemblies of the disconnect coupling 1, namely, the coupling mechanism which brings about the opening and closing of the disconnect coupling 1 (FIG. 4), the end-face side of the cam ring 7 with the various recesses 30 through 35 for the balls 11 (FIG. 5), and the reset mechanism, which closes a freewheel when the disconnect coupling 1 is opened (FIG. 6).

The disconnect coupling 1 is provided for installation in a rotating electric hand-held power tool (not illustrated in the figures), in particular a screwdriver as is used in industrial manufacturing, for example. The disconnect coupling 1 is situated in the powertrain of the hand-held power tool, between the drive motor and a tool receptacle, in particular for a screwing tool such as a screwdriver blade, a hexagon socket tool, or a hexagon head tool. However, the disconnect coupling 1 according to the invention may also be used in other hand-held power tools.

The components of the disconnect coupling 1 are all situated essentially coaxially with respect to an axis which at the same time forms the rotational axis of the rotatable components. At the same time, the disconnect coupling 1, via a ring 48 (not illustrated) that is fixed to the housing, is supported on the housing of the hand-held power tool, and at this location is directly or indirectly rigidly connected to the housing.

The disconnect coupling 1 has a drive shaft 2 whose outer end is designed in the form of a hexagon head 20, for example. The hexagon head 20 is provided for permanent, form-fit, and rotatably fixed coupling to the drive motor (not illustrated) of the hand-held power tool. Coaxially with respect to the drive shaft 2, the disconnect coupling 1 has an output shaft 3 with a hexagon socket 21 formed on its outer end. The hexagon socket 21 is provided for form-fit, rotatably fixed accommodation of exchangeable tools, in particular screwdriver bits of any type. The tools are preferably inserted into the hexagon socket 21 by hand, and are preferably held by friction, a latching mechanism, or by a magnet.

The drive shaft 2 and the output shaft 3 are mounted so that they are rotatable relative to one another by means of a ball bearing 17. During installation of the disconnect coupling 1, the balls of the ball bearing 17 are individually filled into the drive shaft 2 through a radial borehole in the outer bearing shell, and this borehole is then closed with a stopper 18.

The task of the disconnect coupling 1 is to transmit, in the closed state, a torque from the drive shaft 2 and thus from the drive motor to the output shaft 3, and thus to the tool during operation of the hand-held power tool. As soon as the torque transmitted from the drive shaft 2 to the output shaft 3 exceeds a certain settable release torque, the disconnect coupling 1 is to open so that torque is no longer transmittable from the drive shaft 2 to the output shaft 3.

In particular, opening the disconnect coupling 1 when the release torque is exceeded is intended to support the two applications described above.

When a screw connection is established in the clockwise operational direction of the hand-held power tool, the disconnect coupling 1 is to open as soon as the nominal tightening torque of the screw connection is reached (first application). In contrast, upon loosening a screw connection in the counterclockwise operational direction of the hand-held power tool, the disconnect coupling 1 is to open when the required release torque is greater than the maximum motor torque, in order to protect the motor of the hand-held power tool from overload (second application).

Since the two applications are different, the release torque required in each case may also be different. Because the nominal tightening torque differs from one screw connection to another, in particular in the first application, in this case the release torque is to be preselectable by the user of the hand-held power tool.

To achieve the desired opening of the disconnect coupling 1 in the clockwise or counterclockwise direction when the particular release torque is exceeded, the drive shaft 2 is rotatably fixedly connected—and in the example connected in one piece—to a cam ring 7. Various recesses having different axial levels are formed in the end-face side of the cam ring 7 that is axially directed toward the output shaft 3. These recesses are designed in such a way that multiple, in the example three, balls 11 can be accommodated therein and can move therein essentially in the circumferential direction. The precise arrangement and the operating principle of the recesses in the cam ring 7 are described in greater detail below.

For each ball 11, at least one location is provided in the recesses in the cam ring 7 at which the axial level of the recess abruptly changes. In other words, the recess at this location has an axial step. However, the “vertical” wall of the step does not extend exactly in the axial direction, and instead is inclined with respect to same, in particular in such a way that the step forms a steep, but not vertical, ramp from the lower axial level (in the sense of a deeper recess in the end-face side of the cam ring 7) toward the higher axial level.

In the closed state of the disconnect coupling 1, the ball 11 is situated in the recess on the side of the step having the lower axial level, and rests against the step in such a way that the step presses against the ball 11 in the circumferential direction for a predefined rotational direction of the drive shaft 2. In this state of the disconnect coupling 1, a torque may thus initially be transmitted from the cam ring 7 to the ball 11. The disconnect coupling 1 is then in a first switching position.

Situated axially adjacent to the cam ring 7 is a first guide ring 8 that is rotatably fixedly connected—in the example connected in one piece—to the output shaft 3. Thus, neither the cam ring 7 nor the first guide ring 8 is axially movable.

For each ball 11, the first guide ring 8 has a through opening 10 into which the portion of the ball 11 that protrudes axially beyond the cam ring 7 is guided. Each through opening 10 has a linear design, i.e., in the form of an elongated hole, and extends in the first guide ring 8 from a radially outwardly situated end to a radially inwardly situated end in a direction running at an angle to the radial direction. The radially outwardly situated end of the elongated hole is spaced apart from the outer circumference of the first guide ring 8. This results in forced guiding of each ball 11 in an elongated hole. It is not possible for a ball 11 to be lost. The axial extension of the first guide ring 8 is dimensioned in such a way that each ball 11, in any possible position that it can assume in a recess in the cam ring 7, rests with its largest diameter against the inner walls of the associated through opening 10, and at the same time, a portion of the ball 11 protrudes axially from the through opening 10 on the side opposite from the cam ring 7. The first guide ring 8 with the through openings 10 provided therein thus acts like a cage for the balls 11. In this way, a torque can always be transmitted between the balls 11 and the second guide ring 8, and thus to the output shaft 3.

Situated on the side of the first guide ring 8, opposite from the cam ring 7, is a second guide ring 9 whose end face pointing toward the first guide ring 8 is completely flat. The second guide ring 9 is rotatably and axially displaceably mounted on the output shaft 3, preferably by means of a slide bearing. As explained in greater detail below, the second guide ring 9 is axially pretensioned against the cam ring 7 so that the flat end face of the second guide ring is pressed against the balls 11.

The balls 11 are thus forcibly guided in all directions, namely, in the axial direction via the recesses in the end-face side of the cam ring 7 and via the flat end-face side of the second guide ring 9, and in the radial and circumferential directions via the through openings 10 in the first guide ring 8. This forced guidance of the balls 11 prevents the balls 11 from uncontrollably moving during rotation of the drive shaft 2 and the output shaft 3 and becoming lost inside the housing of the hand-held power tool.

Based on the above description, it is clear that in the closed state of the disconnect coupling 1 a torque can be transmitted from the drive shaft 2, via the cam ring 7, the balls 11, and the first guide ring 8, to the output shaft 3. The second guide ring 9 itself does not take part in the torque transmission, but instead forms part of the axial guiding of the balls 11.

As mentioned above, in the closed state of the disconnect coupling 1 each ball 11 rests against the associated step in a recess in the end-face side of the cam ring 7, wherein the step forms a steep, but not vertical, ramp, and a torque can be transmitted from the ramp to the ball 11 in the predefined rotational direction of the drive shaft 2. The surface of the ball 11 and the ramp thus form a wedge gear. At the same time, the ball 11 is axially pretensioned against the end face of the cam ring 7 by the second guide ring 9. This pretensioning is dimensioned in such a way that when the torque transmitted between the ramp and the ball 11 exceeds a first release torque, the ball 11 “climbs up” the ramp due to the wedge effect, and enters the axially higher portion of the recess in the end face of the cam ring 7.

As explained in greater detail below, this recess is situated in such a way that the ball 11 can move freely in the circumferential direction in the axially higher portion of the recess. In this state of the disconnect coupling 1, it is thus no longer possible for torque to be transmitted between the cam ring 7 and the ball 11, or thus between the drive shaft 2 and the output shaft 3. The disconnect coupling 1 is then in a second switching position and in the open state.

The ramp in the recess in the end face of the cam ring 7 thus acts as a first switching cam 31, whose surmounting by the ball 11 in a first rotational direction brings about a transition of the disconnect coupling 1 from the closed state into the open state. In a second rotational direction opposite from the first rotational direction, this ramp likewise acts as a first switching cam 31, whose surmounting by the ball 11 brings about a transition of the disconnect coupling 1 from the open state into the closed state.

The end-face side of the cam ring 7 together with the recesses for the balls 11 situated therein is now described in detail. In the example three balls 11 are provided, and the end-face side of the cam ring 7 has recesses for each ball 11 that are offset by 120 degrees, and thus has threefold rotational symmetry.

The recesses for a ball 11 include, firstly, an elongated ball pocket 30 that has a lower axial level than all other recesses in the end-face side of the cam ring 7. The ball pocket 30 extends approximately in the circumferential direction, but is slightly radially inwardly curved toward one end.

The two ends of the ball pocket 30, at which the low axial level of the ball pocket 30 merges into the higher axial level of the surroundings of the ball pocket 30, thus form a first switching cam 31 for a torque transmission during a clockwise rotation of the drive shaft 2, or form a second switching cam 32 for a torque transmission during a counterclockwise rotation of the drive shaft 2, to the output shaft 3.

When the first release torque is exceeded for a clockwise rotation of the drive shaft 2, the ball 11, as described above, surmounts the first switching cam 31 and enters the adjoining discharge track 33, which leads radially inwardly in a helical manner. The discharge track 33 preferably has the shape of a logarithmic spiral to allow uniform, jerk-free movement of the ball 11. In addition, the slight radially inward curvature of the ball pocket 30 is selected in such a way that the ball pocket 30 merges into the discharge track 33 with a “smooth” transition, likewise to allow uniform, jerk-free movement of the ball 11.

Simultaneously with its radially inward movement in the discharge track 33, the ball 11 moves radially inwardly along the longitudinal extension of the through opening 10 in the first guide ring 8. Since the through opening 10 is not situated radially, but, rather, is inclined at an angle to a radial direction, the ball 11 can slide off on the inner surface of the through opening 10 at an oblique angle, thus reducing friction and preventing possible self-locking during the movement of the ball 11 in the through opening 10.

In the radially inner area of the end-face side of the cam ring 7, the discharge track 33 opens into a closed, circular freewheeling track 34, having a constant axial level, in which the ball 11 can circulate for as long as desired.

When the ball 11 is present in the discharge track 33 or in the freewheeling track 34, and thus encounters no mechanical resistance in the circumferential direction, torque can no longer be transmitted from the drive shaft 2 to the output shaft 3. Consequently, the disconnect coupling 1 is then in the open state, thus preventing the nominal tightening torque of a screw connection from being exceeded.

Since the discharge track 33 and the freewheeling track 34 have a higher axial level than the ball pocket 30, the ball 11 moves in the axial direction toward the output shaft 3. As a result, the second guide ring 9, which is pretensioned against the balls 11 and the cam ring 7, is also displaced in this axial direction.

The second guide ring 9 is mounted so that it is rotatable with respect to a slide ring 40, whose function is described in greater detail below, by means of a ball bearing 6, so that the slide ring 40 itself does not co-rotate. The second guide ring 9 and the slide ring 40 are connected by the ball bearing 6 to form a unit, and therefore cannot move axially relative to one another, but, rather, can only be moved together axially.

The slide ring 40 at its outer circumference has an opening 42 which may contain a position indicator, for example a permanent magnet (not illustrated). Mounted in the housing of the hand-held power tool is an appropriate sensor, for example a magnetic sensor, which can detect the axial displacement of the position indicator, and thus of the slide ring 40.

Based on the axial displacement of the slide ring 40, the sensor recognizes that the disconnect coupling 1 has transferred into the open state, and relays a corresponding signal to the controller of the drive motor of the hand-held power tool. The motor is subsequently switched off. After the rotational movement of the motor comes to a standstill, the rotational direction of the drive shaft 2 is changed. The ball 11, which is circulating clockwise in the freewheeling track 34 (in the orientation of the cam ring 7 illustrated in FIG. 5), now circulates counterclockwise after the reversal of the rotational direction, and at the “branch” or opening 36 of one of the discharge tracks 33 once again enters this discharge track 33, and the end thereof re-enters the associated ball pocket 30. The guide 37 that results from the arrangement and the different level of the freewheeling track 34 or of the discharge track 33 ensures that switching of the ball 11 from the freewheeling track 34 into the discharge track 33 always takes place at the opening 36. This may be important in particular when the disconnect coupling 1 includes more than one ball 11. This prevents a situation in which one ball 11 is situated in the freewheeling track 34 and another ball 11 is in the discharge track 33. This ensures process reliability in the opening and closing of the disconnect coupling 1. The renewed axial movement of the slide ring 40 in the direction of the drive shaft 2, associated with the transfer of the ball 11 into the ball pocket 30, is in turn recognized by the sensor, and the motor controller subsequently stops the rotation of the motor. The disconnect coupling 1 is thus once again in the closed state.

In contrast, during a counterclockwise rotation of the drive shaft 2, at the end of the ball pocket 30 opposite from the first switching cam 31 the ball 11 rests against the second switching cam 32, so that a torque can be transmitted from the cam ring 7 to the ball 11 and, as described above, via the first guide ring 8 to the output shaft 3. The disconnect coupling 1 is then in a third switching position.

If during the counterclockwise rotation of the drive shaft 2 the second release torque is now exceeded, the ball 11 surmounts the second switching cam 32 and enters the adjoining cam track 35. The cam track 35 circulates at the outer radial edge of the cam ring 7, in a circle that is concentric with the freewheeling track 34, and is interrupted only by the ball pockets 30. The cam track 35, apart from the ball pockets 30, thus has a constant axial level that is higher than that of the ball pockets 30.

The ramp at the end of the ball pocket 30 that forms the second switching cam 32 is preferably steeper than the ramp at the end of the ball pocket 30 that forms the first switching cam 31. The second release torque is thus also preferably greater than the first release torque.

The ball 11 can circulate in the cam track 35 at least up to the next ball pocket 30, i.e., over a rotational angle range of 5 degrees to 120 degrees, without encountering mechanical resistance in the circumferential direction. Thus, during this movement of the ball 11, no torque can be transmitted from the drive shaft 2 to the output shaft 3. The disconnect coupling 1 is then in a fourth switching position. In the fourth switching position, the disconnect coupling 1 is also in the open state and prevents the maximum motor torque from being exceeded, in particular when this is not sufficient to loosen a screw connection.

In this case as well, the slide ring 40 is axially displaced when the disconnect coupling 1 is opened, which in turn is detected by the sensor. The motor controller subsequently allows the motor to continue running with counterclockwise rotation, for example at a low rotational speed, until each ball 11 has fallen back into the respective ball pocket 30. In this case a prior reversal of the rotational direction of the motor is not necessary. The disconnect coupling 1 is thus once again in the closed state. Allowing the motor to continue running at a low rotational speed may even be dispensed with, since at the latest, upon the next use of the hand-held power tool—regardless of whether it is operated in the clockwise or counterclockwise direction—the balls 11 fall back into ball pockets 30, and at the latest the disconnect coupling 1 is then back in the closed state.

The first and second release torques may be preset as a function of the desired application, in particular as a function of the nominal tightening torque of a screw connection to be established, via the axial pretensioning of the second guide ring 9 against the balls 11 and the cam ring 7.

This pretensioning may be produced by an axially pretensioned compression spring 12 that is designed as a coil spring and extends around the output shaft 3. At one end the compression spring 12 is supported on the second guide ring 9, and at the other end is supported on a pressure ring 13, which at its inner side engages with a protrusion (not illustrated) into a flat area 5 (FIG. 6) on the output shaft 3, and which is thus axially displaceable but not rotatable with respect to the output shaft 3. On the side of the pressure ring 13 facing away from the compression spring 12, an adjusting ring 15 is screwed onto a thread 4 of the output shaft 3. The thread 4 is preferably a left-hand thread. Multiple (in the example, six) detent balls 14, which are embedded at uniform angular intervals in the end-face side of the pressure ring 13 facing the adjusting ring 15, can engage with multiple (in the example, twelve) boreholes 16, likewise situated at uniform angular intervals, on the opposite end-face side of the adjusting ring 15. The adjusting ring 15 may thus be rotated against the elastic force of the compression spring 12, in each case by a certain angle (in the example, 30 degrees), which the user perceives as individual locking steps, and may be further screwed onto the output shaft 3 or unscrewed from the output shaft 3. The pretensioning of the compression spring 12, and thus the first and second release torques, is/are increased or decreased with each locking step. The adjusting ring 15 is enclosed in the hand-held power tool by an actuating ring (not illustrated) which is preferably made of a non-slip plastic and which can be easily manually adjusted by the operator.

As described above, the rotational direction of the motor is briefly reversed from clockwise to counterclockwise operation when the coupling has opened in the clockwise operational direction of the motor due to an exceedance of the first release torque, so that the balls 11 move back into their ball pockets 30 to the left, i.e., counterclockwise, due to a relative rotation of the drive shaft 2 and thus of the cam ring 7 with respect to the balls 11, and the disconnect coupling 1 thus recloses after opening. Since the balls 11 are forcibly guided by the first guide ring 8, and the first guide ring 8 is rotatably fixedly connected to the output shaft 3, the output shaft 3 must be prevented from co-rotating during the counterclockwise rotation of the drive shaft 2, since otherwise, such a relative rotation between the drive shaft 2 and the output shaft 3 does not occur.

The co-rotation of the output shaft 3 may be prevented, for example, by the tool remaining engaged with the previously fastened screw after the reversal of the rotational direction of the motor. However, during practical use of the hand-held power tool it cannot be ensured that the user keeps the tool engaged with the screw immediately after the nominal tightening torque of the screw is reached and the associated opening of the disconnect coupling 1 takes place. As soon as the tool is disengaged from the screw, co-rotation of the output shaft 3 is no longer ruled out.

To reliably prevent co-rotation of the output shaft 3 in any state of the disconnect coupling 1 after the rotational direction of the motor is reversed, i.e., during counterclockwise operation of the motor, the disconnect coupling 1 has a reset mechanism, described below (also see FIG. 6).

The reset mechanism is triggered when the disconnect coupling 1 is opened by the above-described axial movement of the slide ring 40. As is most clearly discernible in FIG. 2, the slide ring 40 radially outwardly overlaps the second guide ring 9, the first guide ring 8, the balls 11, and the cam ring 7 with multiple (in the example, three) claws 41 that point in the direction of the drive shaft 2 and are distributed over the circumference of the slide ring 40. The claws 41 are supported on a radially outer area of the end face of a freewheel ratchet ring 43 which has approximately the same diameter as the slide ring 40, and thus has a slightly larger diameter than the cam ring 7, the first guide ring 8, and the second guide ring 9. Instead of multiple claws 41, the slide ring 40 may have a circumferential, cylindrical lateral surface, which is likewise supported on the radially outer area of the end face of the freewheel ratchet ring 43.

The freewheel ratchet ring 43 is axially displaceable but not rotatable, since it is axially guided by multiple axially arranged guide pins 51. For this purpose, the freewheel ratchet ring 43 has grooves 52 which together with the guide pins 51 form an axial sliding guide. The guide pins 51 in turn are rigidly connected to a ring 48 fixed to the housing on the outer side of a cylindrical section 49 of the ring, in that they are embedded in grooves 53 in the cylindrical section 49 of the ring 48 fixed to the housing. Via multiple recesses 50 in its circumference, the ring 48 fixed to the housing is rigidly connected to the housing of the hand-held power tool by means of protrusions in the housing, and therefore is neither axially displaceable nor rotatable. The freewheel ratchet ring 43 is thus axially displaceably mounted on the cylindrical section 49 of the ring 48 fixed to the housing, but cannot rotate due to the guiding by the guide pins 51.

The ring 48 fixed to the housing also has the function of radially outwardly supporting a ball bearing 22 in which the drive shaft 2 is radial inwardly supported. The bearing between the ring 48 fixed to the housing and the drive shaft 2 is further secured by a locking ring 19.

Furthermore, a wave spring 47 that axially pretensions the freewheel ratchet ring 43 in the direction of the output shaft 3 is situated between a flange of the ring 48, fixed to the housing, having a larger diameter than the cylindrical section 49, and a flange of the freewheel ratchet ring 43 having approximately the same diameter as the flange of the ring 48 fixed to the housing. Instead of a wave spring, for example some other compression spring, in particular a coil spring, may be used for this purpose.

The elastic force of the wave spring 47 is always less than the elastic force of the compression spring 12, so that the pretensioning of the unit, made up of the slide ring 40 and the second guide ring 9, against the balls 11 is not discontinued.

On its end-face side directed toward the first guide ring 8, the freewheel ratchet ring 43 has multiple protrusions, distributed over its circumference, which serve as freewheel ratchets 44 (FIG. 6). The end-face side 45 of a cylindrical shoulder of the first guide ring 8, which axially overlaps the cam ring 7 radially outwardly, has a serrated profile viewed in the circumferential direction. Multiple freewheel teeth 46 are thus formed with which freewheel ratchets 44 can engage. In the open state of the disconnect coupling 1, when the balls 11 are outside the ball pockets 30, the freewheel ratchet ring 43 is axially pressed against the first guide ring 8 by the elastic force of the wave spring 47. The freewheel ratchets 44 can then come into engagement with the freewheel teeth 46, and the freewheel is in the closed state. The direction of the serrated profile of the end-face side 45 of the cylindrical shoulder of the first guide ring 8, and thus the arrangement of the freewheel teeth 46, is selected in such a way that the first guide ring 8 and thus the output shaft 3 can rotate only clockwise but not counterclockwise.

When the disconnect coupling 1 is closed, the claws 41 of the slide ring 40 axially press the freewheel ratchet ring 43 against the elastic force of the wave spring 47, away from the first guide ring 8, so that the freewheel ratchets 44 cannot engage with the freewheel teeth 46, and the freewheel is opened and has no effect.

In contrast, when the disconnect coupling 1 is open, the claws 41 of the slide ring 40 do not press against the freewheel ratchet ring 43, since the unit made up of the slide ring 40 and the second guide ring 9 is axially displaced by the balls 11 in the direction of the output shaft 3, so that the wave spring 47 axially presses the freewheel ratchet ring 43 against the first guide ring 8, and the freewheel ratchets 44 can thus engage with the freewheel teeth 46 and the freewheel is closed. This brings about the desired behavior of the freewheel, namely, that it is closed only in the open state of the disconnect coupling 1, in which the reversal of the rotational direction of the motor also takes place, and which thus in counterclockwise operation of the motor hinders the output shaft 3 from co-rotating.

In the case that, in counterclockwise operation of the motor, the disconnect coupling 1 is opened due to an exceedance of the second release torque, the freewheel closes, and the balls 11 are situated in the cam track 35. However, this has no further effects since, as described above, in this case the balls do not have to return from the freewheeling track 34 back into the ball pockets 30, and therefore no reversal of the rotational direction of the motor is necessary, for which co-rotation of the output shaft 3 must be prevented. The state change from the open state into the closed state of the freewheel has no effect when the disconnect coupling 1 is open during counterclockwise operation of the motor.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A torque-dependent releasable disconnect coupling for an electric hand-held power tool to selectively transmit a torque from a drive shaft to an output shaft that is coaxial with respect to the drive shaft, the disconnect coupling comprising:
a cam ring that is rotatably fixedly connectable to the drive shaft or to the output shaft;
an axially nondisplaceable first guide ring that is rotatably fixedly connectable to the other of the drive shaft and the output shaft;
at least one switching element or a ball, that is guided from the first guide ring in a circumferential direction and/or in a radial direction; and
a second guide ring, the cam ring and the second guide ring being axially pretensioned against one another and accommodate the at least one switching element arranged axially between them,
wherein the disconnect coupling is adapted to be brought from a first switching position, in which the cam ring is connected in a torque-transmitting manner to the first guide ring in a first rotational direction or clockwise in the axial direction viewed from the drive shaft toward the output shaft, into a second switching position in which the cam ring is freely rotatable with respect to the first guide ring, and
wherein the cam ring is designed such that when the disconnect coupling is in the first switching position, the at least one switching element is deflected in the axial direction relative to the cam ring against the action of the pretensioning when a first release torque that acts in the first rotational direction is exceeded, as a result of which the disconnect coupling is brought into the second switching position.

2. The disconnect coupling according to claim 1, wherein the cam ring comprises:
at least one depression or a ball pocket, in which the at least one switching element is accommodated in the first switching position, wherein the at least one depression forms a first switching cam against which the at least one switching element rests in the first switching position;
a freewheeling track closed in the circumferential direction, and on which the at least one switching element circulates in the second switching position; and
at least one discharge track that connects the at least one depression and the freewheeling track, and on which the at least one switching element is adapted to move from the at least one depression to the freewheeling track and vice versa,
wherein, when the first release torque is exceeded, the at least one switching element is deflectable in the axial direction, and the disconnect coupling is brought into the second switching position by moving the at least one switching element from the at least one depression, via the at least one discharge track, into the freewheeling track.

3. The disconnect coupling according to claim 2, wherein the axial level of the at least one discharge track rises from the depression in the direction of the freewheeling track, and is always lower than or at the same height as the axial level of the freewheeling track.

4. The disconnect coupling according to claim 1, wherein the first guide ring is designed as a cage ring having at least one through opening, and the at least one switching element is accommodated in the at least one through opening.

5. The disconnect coupling according to claim 4, wherein the at least one through opening has an elongated shape or an elongated straight shape, whose direction of extension is inclined with respect to a radial direction.

6. The disconnect coupling according to claim 2, wherein the at least one depression inside the cam ring is spaced apart from the outer circumference of the cam ring.

7. The disconnect coupling according to claim 2, wherein the freewheeling track has a constant axial level.

8. The disconnect coupling according to claim 2, wherein the at least one discharge track has, at least in part, the shape of a logarithmic spiral.

9. The disconnect coupling according to claim 1, wherein the disconnect coupling is adapted to be brought from a third switching position, in which the cam ring is connected in a torque-transmitting manner to the first guide ring in a second rotational direction opposite to the first rotational direction or counterclockwise in the axial direction viewed from the drive shaft toward the output shaft, into a fourth switching position in which the cam ring is freely rotatable with respect to the first guide ring, and
wherein the cam ring is designed in such a way that when the disconnect coupling is in the third switching position, the at least one switching element is deflected in the axial direction relative to the cam ring against the effect of the pretensioning, when a second release torque that acts in the second rotational direction is exceeded, as a result of which the disconnect coupling is brought into the fourth switching position.

10. The disconnect coupling according to claim 2, wherein the at least one switching element in the third switching position is accommodated in the at least one depression, wherein the at least one depression forms a second switching cam against which the at least one switching element rests in the third switching position, wherein the cam ring also has a cam track that is largely closed in the circumferential direction and interrupted only by the at least one depression, and on which the at least one switching element in the fourth switching position can circulate, at least in parts, wherein the at least one switching element is deflectable in the axial direction when the second release torque is exceeded, and the disconnect coupling may be brought into the fourth switching position by moving the at least one switching element from the at least one depression into the cam track.

11. The disconnect coupling according to claim 1, wherein the disconnect coupling has a freewheel that is adapted to be opened and closed, and which is configured to be supported on a housing of the electric hand-held power tool, and which in the closed state allows rotation of the output shaft in the first rotational direction and blocks rotation of the output shaft in the second rotational direction, and in the open state does not affect the rotatability of the output shaft.

12. The disconnect coupling according to claim 11, wherein the freewheel is a ratchet-type freewheel in which at least one freewheel ratchet engages with at least one freewheel tooth, wherein the at least one freewheel ratchet is situated on an axially displaceable, nonrotatable freewheel ratchet ring that is axially pretensioned against the at least one freewheel tooth, and the at least one freewheel tooth is situated at an end-face side of the first guide ring.

13. The disconnect coupling according to claim 12, wherein the freewheel is adapted to be closed and opened by an axial displacement of the freewheel ratchet ring, which is achieved by axially displacing the second guide ring.

14. The disconnect coupling according to claim 12, wherein the cam ring and the first guide ring are situated axially between the freewheel ratchet ring and the second guide ring, and the second guide ring or a component that is connected to the second guide ring and axially nondisplaceable with respect to same axially overlaps the cam ring and the first guide ring.

15. An electric hand-held power tool, in particular a screwdriver, comprising a disconnect coupling according to claim 1.

16. The disconnect coupling according to claim 1, wherein the power tool is a screwdriver.
